(19) United States
(12) Patent Application Publication
(10) Pub. No.: US 2007/0163719 A1
(43) Pub. Date: Jul. 19, 2007

(54) Metal back layer forming device

(75) Inventors: Yasunori Gamo, Saitama-ken (JP); Hajime Tanaka, Gunma-ken (JP); Masayuki Yoshii, Saitama-ken (JP); Masaaki Inamura, Saitama-ken (JP); Takeo Ito, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/585,948

(22) PCT Filed: Dec. 24, 2004
(86) PCT No.: PCT/JP04/19297

§ 371 Date: Jul. 11, 2006

(30) Foreign Application Priority Data
Jan. 13, 2004 (JP) 2004-006000

(51) Int. Cl. B65H 37/00; B65C 9/18

(52) U.S. Cl. 156/540; 156/542

(57) ABSTRACT

A metal back layer forming device including a film withdrawing roller for withdrawing, starting at one end, a transfer film from the wound body of the transfer film formed by applying at least a metal film onto a base film, a film carrying mechanism such as a turn roller for carrying the transfer film withdrawn from the wound body to the downstream side, a transfer roller for transferring the metal film by heating while pressing the carried transfer film against a phosphor screen installed on a face plate, and a film winding roller for winding while releasing the base film from the transfer film which completes transfer treatment.

### TECHNICAL FIELD

The present invention relates to a device for forming a phosphor surface with a metal back, and more specifically to a metal back layer forming device for forming a metal back layer on a phosphor surface of a flat-panel image display device such as a field emission display (hereinafter referred to as an “FED”).

### BACKGROUND ART

Conventionally, for the phosphor surface of an image display device such as a cathode ray tube (CRT) or an FED, the structure of a metal back system having a metal film of Al or the like formed on the inner surface (surface on the side opposite to the face plate) of a phosphor layer has been used extensively.

The metal back system aims to reflect light emitted from the phosphor layer, which is excited by electrons emitted from an electron source, to the metal film (metal back layer) so as to send emission energy to the front surface of the face plate more efficiently, and also to give electrical conductivity to the phosphor surface to make it function as an electrode. As a simple metal back layer forming method, there is proposed a transfer method which forms a metallized film on a film to which a release agent is applied and transfers the metal film onto a phosphor layer with an adhesive agent (for example, Patent Document 1).

According to the above transfer method, a nondisplay region around the face plate is masked by a method of adhering a masking tape or the like, and transfer is performed by a hot stamp method that presses the transfer film while heating. And, for the hot stamp method, there is a frequently used method that a metal film is formed on a base film, which is cut to a prescribed size, to produce a transfer film, an adhesive agent is coated onto the metal film of the transfer film by special coating equipment, and it is dried.
Patent Document 1: JP-A 63-102139 (KOKAI)

### SUMMARY OF THE INVENTION

Problems to be Solved by the Invention

But, the above-described transfer method requires a large amount of labor and time and had a problem in view of a production efficiency.

And, if the transfer film had wrinkles at the time of coating the adhesive agent, uneven coating of the adhesive agent was produced on the wrinkle portion. In that case, there was a problem that a homogeneous metal back layer could not be formed in the subsequent transfer step because the uneven coating of the adhesive agent appeared as unevenness of the metal back layer.

Therefore, it was necessary to devise a way of stretching the transfer film in the adhesive agent coating step to prevent the generation of wrinkles on the transfer film. For example, where a method that fixes the transfer film by using a masking tape or the like while pulling the film edges is employed, the stretching work was variable depending on a level of skill of a worker, and it was hard to provide the transfer films with quality of a prescribed level or higher. And, if the transfer were performed without avoiding the production of wrinkles on the transfer film, there was a problem that the wrinkled portion of the metal back layer was cracked or the metal back layer could not be formed properly, resulting in a decrease in a yield.

In a case where the transfer film to be processed was in the shape of a rolled sheet in the initial state, static electricity was often produced when the transfer film was withdrawn from the roll or pressed by a transfer roller while heating. And, if the transfer film were electrostatically-charged, foreign matters contained in the peripheral atmosphere adhered to the transfer film, resulting in a problem that the adhesive agent was coated unevenly or the metal film was transferred defectively because of the foreign matters.

The present invention has been made in view of the above circumstances and provides a metal back layer forming device that can improve production efficiency in a step of forming a metal back layer.

Means for Solving the Problems

According to an aspect of the invention, there is provided a metal back layer forming device, comprising a film withdrawing mechanism which withdraws, starting at one end, a transfer film from a wound body of the transfer film formed by applying at least a metal film onto a base film; a film carrying mechanism which carries the transfer film withdrawn, starting at one end, by the film withdrawing mechanism to the downstream side; a transfer mechanism which transfers the metal film via an adhesive layer by heating while pressing the transfer film carried by the film carrying mechanism against a phosphor surface disposed on the face plate; and a film winding mechanism which winds while peeling the base film from the transfer film from which the metal film is transferred by the transfer mechanism.

The metal back layer forming device of the present invention can comprise an adhesive agent coating mechanism which coats an adhesive agent onto the metal film of the transfer film, and an adhesive agent drying mechanism which dries the adhesive agent coated by the adhesive agent coating mechanism at the previous stage of the transfer mechanism. And, it can further comprises a wrinkle-removing mechanism which removes wrinkles which might be produced on the transfer film on the downstream side in the vicinity of the film withdrawing mechanism and in the vicinity of the disposed position of the transfer mechanism. And, it can further comprises a static elimination mechanism which removes static electricity from the electrostatically charged transfer film on the downstream side in the vicinity of the film withdrawing mechanism, on the side of the surface of the base film opposite to the adhesive agent coated surface of the transfer film on the downstream side of the adhesive agent coating mechanism, and in the vicinity of the disposed position of the transfer mechanism.

Effects of the Invention

According to the present invention, the step of forming the metal back layer realized by transferring the metal film and the adhesive layer on the transfer film to the phosphor layer of the face plate can be substantially automated, and production efficiency can be improved.

### BRIEF DESCRIPTION OF THE DRAWINGS

FIG. 1 is a diagram schematically showing the metal back layer forming device according to an embodiment of the invention.

FIG. 2 is a sectional view schematically showing a state that a nondisplay region of an FED is masked and a transfer film is disposed on a phosphor screen.

FIG. 3 is a sectional view of an FED provided with a phosphor surface with a metal back formed by the metal back layer forming device shown in FIG. 1.

### EXPLANATION OF REFERENCE NUMERALS

1 . . . metal back layer forming device, 2 . . . film withdrawing roller, 6 . . . adhesive agent coating equipment, 7 . . . air blower, 8 . . . drying machine, 9 . . . turn roller, 10, 11, 19 . . . static elimination equipment, 12 . . . transfer roller, 14 . . . slide table, 21 . . . FED, 22 . . . phosphor screen, 29 . . . metal back layer, 26a . . . metal film, 26b . . . base film, and 27 . . . face plate.

### BEST MODE FOR IMPLEMENTING THE INVENTION

Best modes for carrying out the invention will be described with reference to the drawings.

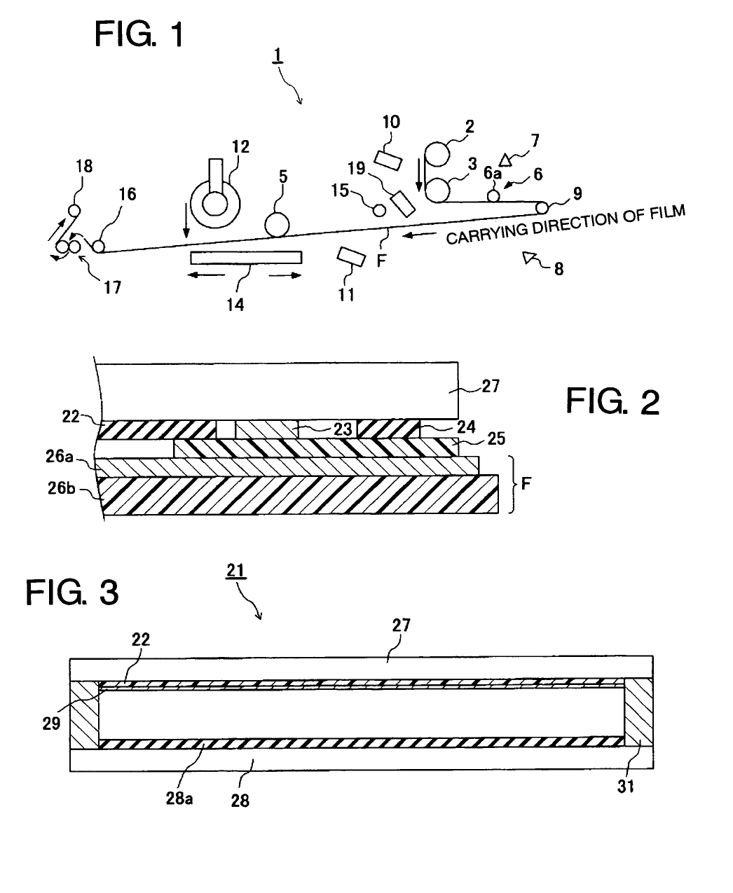

FIG. 1 is a diagram schematically showing the metal back layer forming device according to an embodiment of the invention, FIG. 2 is a sectional view schematically showing a state that a nondisplay region of an FED is masked and a transfer film is disposed on a phosphor surface (phosphor screen), and FIG. 3 is a sectional view of an FED provided with a phosphor surface with a metal back.

As shown in these drawings, a metal back layer forming device 1 is a device for forming, for example, a metal back layer 29 of an FED 21, and transfers a transfer film F, which is formed long, while carrying it. This metal back layer forming device 1 is provided with motors for applying a driving force to various types of rollers for carrying the transfer film F and has a back tension function for tensioning the transfer film F being carried.

FIG. 2 shows a state that the transfer film F is disposed on a phosphor screen 22. In FIG. 2, reference numeral 27 is a face plate, 22 is the phosphor screen; 23 is a peripheral black matrix, 24 is an outer frame part, and 25 is a masking tape. Reference numeral F is the transfer film, 26b is a base film of the transfer film F, and 26a is a metal film. A release agent layer and a film adhesive layer of the transfer film F are not shown.

The metal back layer forming device 1 is mainly comprised of a film withdrawing roller 2, a film wrinkle-removing roller 3 which is disposed on the upstream side, a film wrinkle-removing roller 5 which is disposed on the downstream side, an adhesive agent coating equipment 6, an air blower 7, a drying machine 8, a turn roller 9 which changes a carrying direction of the transfer film F, static elimination equipments 10, 11, 19, a rubber transfer roller 12 which presses the transfer film F against the metal back layer while heating, a slide table 14, a film holddown roller 15 which is disposed on the upstream side, a film holddown roller 16 which is disposed on the downstream side, tension rollers 17, and a film winding roller 18.

The film withdrawing roller 2 is a roller which withdraws, starting at one end, the transfer film F from a wound body which is a roll of the transfer film F having the metal film 26a formed on the base film 26b with a release layer interposed. The film wrinkle-removing rollers 3, 5 are rollers, for example, expander rolls, which remove wrinkles by pulling the transfer film F being carried in its width direction. Here, the film wrinkle-removing roller 3 is disposed on the downstream side in the vicinity of the film withdrawing roller 2, and the film wrinkle-removing roller 5 is disposed at the periphery of the

The adhesive agent coating equipment 6 is a device for coating an adhesive agent onto the metal film of the transfer film F and has a bar coater roller 6a and the like. The air blower 7 blows air of normal temperature (20° C.) to the transfer film F on which the adhesive agent is coated. The drying machine 8 blows hot air to dry the adhesive agent coated to the transfer film F. The turn roller 9 reverses (turns back) the carrying direction of the transfer film F. Various types of rollers including the turn roller 9 carry the transfer film F which is withdrawn, starting at one end, by the film withdrawing roller 2 to the downstream side. The static elimination equipments 10, 11 remove static electricity without contacting, which might generate in the transfer film F being carried. Here, the static elimination equipment 10 is disposed on the downstream side in the vicinity of the film withdrawing roller 2, and the static elimination equipment 19 is disposed on the downstream side of the adhesive agent coating equipment 6 and on the side of the surface of the base film opposite to the adhesive agent coated surface of the transfer film F. And, the static elimination equipment 11 is disposed at the periphery of the position where the transfer roller 12 is disposed.

The transfer roller 12 is a rubber roller which presses the transfer film F against the phosphor surface (phosphor screen) 22 of the face plate 27 while heating. The slide table 14 is disposed at a position opposite to the transfer roller 12 with respect to the transfer film F, and the face plate 27 on which the phosphor screen 22 is formed is placed on it. Besides, the F is pressed by the transfer roller 12 and is movable in a normal carrying direction of the transfer film F and in its opposite direction. The film holddown rollers 15, 16 press the transfer film F being carried against a carrying guide side (not shown) to restrict a carrying position in the thickness direction of the transfer film F. The tension rollers 17 apply a prescribed tension to the transfer film F being carried. The film winding roller 18 winds sequentially starting at the leading end in the carrying direction while peeling the base film 26b from the transfer film F undergone the transfer processing.

Here, a structure of the FED 21 to be produced in this embodiment will be described briefly.

The FED 21 has a phosphor surface with a metal back, and to form the phosphor surface with the metal back, for example, a stripe light-absorbing layer (light blocking layer) of a black pigment is formed on the inner surface of the face plate 27 by a photolitho method. Then, a slurry containing a ZnS-based, Y₂O₃-based or Y₂O₂S-based phosphor of individual colors is coated and, dried, and patterned by the photolitho method. Thus, a phosphor layer of three colors of red (R), green (G) and blue (B) is formed among the pattern of the light-absorbing layer to form the phosphor screen 22. The phosphor layer of the individual colors can also be formed by a spray method or a printing method. And, on the inner surface of the face plate 27, the peripheral black matrix 23 of a black pigment and the outer frame part 24 of a silver paste film are formed on a nondisplay region around the phosphor screen 22.

Then, masking tape 25 is adhered to the nondisplay region, where the peripheral black matrix 23 and the outer frame part 24 are formed, to cover the outer edge portion of the phosphor screen 22. Then, the transfer film F, which has a release agent layer, the metal film 26a of Al or the like and a film adhesive layer stacked sequentially on the base film 26b formed of polyester resin or the like, is disposed on the masked phosphor screen 22 to transfer the metal film 26a.

Cellulose acetate, wax, fatty acid, fatty acid amide, fatty acid ester, rosin, acryl resin, silicone, fluorine resin and the like can be used as the release agent for the transfer film. They are appropriately selected and used depending on a peel property between the base film and the protective film to be described later. As the film adhesive agent, vinyl acetate resin, ethylene-vinyl acetate copolymer, styrene-acrylic acid resin, ethylene-vinyl acetate-acrylic acid terpolymer resin or the like is used. Besides, the protective film, which contains thermosetting resin, thermoplastic resin, photo-setting resin or the like as a base and a softening agent blended, can also be disposed between the release agent layer and the metal film.

Then, a method of forming the metal back layer by disposing the transfer film F to extend from the phosphor screen 22 to the masking tape 25 of the nondisplay region and transferring the metal film 26a by the metal back layer forming device 1 of this embodiment will be described.

First, the transfer film F which has the metal film 26a formed on the base film 26b with the release agent layer interposed is wound into the shape of a roll on the film withdrawing roller 2. Air having an electricity removal effect is blown to the transfer film F, which is withdrawn from the film withdrawing roller 2, from the non-contact type static elimination equipments 10, 11, 19 to remove or decrease static electricity charged on the transfer film F. Here, if the transfer film F is electrostatically charged, there are adverse effects that surrounding floating matters (dust and the like) are attracted by the transfer film F, and the resultant deposits cause uneven coating of the adhesive agent when the adhesive agent is coated later. Thus, the adhesive layer becomes defective, resulting in that a normal adhesive layer cannot be obtained. Such adverse effects can be suppressed by the static elimination equipments 10, 11, 19.

The electrostatically-charged transfer film F from which static electricity is removed is slid along the film wrinkle-removing rollers 3, 5 to remove wrinkles from the film surface. The adhesive agent is coated by the adhesive agent coating equipment 6 onto the surface of the metal film 26a of the transfer film F having passed along the film wrinkle-removing roller 3. As a method of coating by the adhesive agent coating equipment 6, a coating method using a gravure roll, or the like can be adopted other than the coating method via the bar coater roller 6a of this embodiment. The adhesive agent formed on the metal film 26a of the transfer film F by the adhesive agent coating equipment 6 is dried by the air blower 7 and the drying machine 8. The drying machine 8 blows hot air. And, it is desirable that a velocity of airflow of the air blower 7 is decreased, and a velocity of airflow of the drying machine 8 is set high.

Air having an effect of removing electricity from the static elimination equipment 19 is blown to the side of the base film opposite to the adhesive agent-coated surface of the transfer film F to prevent the surrounding floating matters (dust and the like) from being attracted by the adhesive agent-coated surface of the transfer film F in the adhesive agent drying process, and uneven coating of the adhesive agent due to the deposits can be suppressed from generating.

A series of steps from the withdrawing of the transfer film F to the coating and drying of the adhesive agent is linked, and a carrying speed of the transfer film F can be set in a unit of 0.1 m/min and adjusted in a range of 0.1 m/min to 10 m/min. An adhesive agent coating time can be set in unit of 1 second. And, a coating length of the adhesive agent to the transfer film F can be adjusted by setting the adhesive agent coating time to a given value according to a relational expression (adhesive agent coating length=[film carrying speed]×[adhesive agent coating time]) of the carrying speed of the transfer film F and the adhesive agent coating time.

Then, the face plate 27 having the phosphor screen 22, which has a light-absorbing layer (light blocking layer) and a phosphor layer of red, green and blue arranged in a stripe pattern, is placed on the slide table 14 with the phosphor screen 22 upside. On the inner surface of the face plate 27, the peripheral black matrix 23 of a black pigment and the outer frame part 24 formed of a silver paste film are formed on the nondisplay region around the phosphor screen 22. The masking tape 25 is adhered to the nondisplay region, where the peripheral black matrix 23 and the outer frame part 24 are formed, to cover the outer edge portion of the phosphor screen 22. The slide table 14 is provided with a displacement preventing mechanism for the face plate 27, and its position can be changed depending on the size of the face plate 27.

Then, the transfer film F having the adhesive layer formed on the metal film 26a is carried to a prescribed position on the slide table 14, and the film holddown roller 15 is lowered. At this time, the direction of the transfer film F is made horizontal to the floor surface by the film holddown rollers 15, 16. Then, the transfer film F is pressed against the surface of the phosphor screen 22 by the transfer roller 12 while heating it, and then the base film 26b is peeled from the transfer film F.

Here, as the transfer roller 12, a rubber roller which has a covering layer of natural rubber or silicone rubber formed on the outer circumferential surface of a metallic core material of iron or the like is applied. It is desirable that the rubber covering layer has hardness of 70 to 100 degrees and thickness of 5 to 30 mm. Besides, the transfer roller 12 is heated such that the rubber layer surface as the pressing portion has temperatures of 150° C. to 240° C., and moved on the surface of the base film 26b of the transfer film F at a speed of 1.0 m/min to 8.0 m/min while applying a pressure to adhere the metal film 26a. It is desirable that the pressing force is in a range of 300 kgf/cm² to 1500 kgf/cm² (e.g., 500 kgf/cm²).

The ranges of the surface temperature, the pressing force and the pressing speed of the transfer roller 12 are necessary and sufficient conditions so that the transfer film F is pressed in a sufficiently heated state by contacting the transfer roller 12. If deviated from the above ranges, adhesiveness between the phosphor screen 22 and the metal film 26a shown in FIG. 2 becomes insufficient, and there is a possibility that the transfer of the metal film 26a becomes defective or some cracks are produced as a result of baking. In other words, if the surface temperature of the transfer roller 12 is excessively high, the rubber is damaged by heat and its pressing function is lost. If the pressing speed is excessively slow, it is not desirable because the base film 26b is excessively heated to become soft or melted and cut off at the time of peeling. And, if the surface temperature of the transfer roller 12 is excessively low or its pressing speed is excessively high, it is not desirable because the film adhesive agent is heated insufficiently, adhesion of the metal film 26a becomes insufficient, transfer becomes defective partly or a yield becomes low.

Besides, the transfer roller 12 is provided with an up and down mechanism that vertically moves the roller body, and the pressing value can be adjusted in a range of 0 to 1500 kgf/cm². And, the slide table 14 is provided with a slide mechanism to move in the back and forth direction in the carrying direction of the transfer film F as described above. The moving speed of the slide table 14, namely the transfer speed, can be changed its set value as desired in a range of 0.1 m/min to 10.0 m/min and in a unit of 0.1 m/min.

If transfer is forcedly performed using the transfer film F having many wrinkles, the metal back layer has cracks and wrinkled defects, a normal metal back is not applied, and the prescribed functions are heavily hindered. But, the metal back layer forming device 1 of this embodiment can remove the wrinkles from the transfer film F by the actions of the film wrinkle-removing rollers 3, 5 at the time of pressing by the transfer roller 12 while heating. As a result, the obtained metal back layer 29 has good quality.

And, where the base film 26b of the transfer film F is peeled, air having an electricity removal effect is blown to the peeling surface from the static elimination equipment 11 to suppress the generation of static electricity. At this time, if the generation of static electricity is unattended, there is a possibility that surrounding floating matters and the like adhere to the transferred metal back layer, and when the next press step is then performed, a defect such as a crack, an opening or the like is produced in the metal back layer, and the prescribed functions are considerably deteriorated.

The base film 26b of the transfer film F, which is through the transfer processing, is passed through the film holddown roller 16 in conjunction with the adhesive agent coating operation which is performed at the rear portion in the carrying direction, then passed through the tension rollers 17, and wound by the film winding roller 18. The film winding roller 18 is provided with a drive mechanism such as a motor and has a back tension function which holds a tension so that the film is not carried during standby.

In this embodiment, after the transfer film F is disposed on the phosphor screen 22 as described above, the film adhesive layer is adhered to the top surface of the phosphor screen 22 by pressing by the transfer roller 12 while heating. Thus, after the metal film 26a of Al or the like is transferred onto the phosphor screen 22 of the face plate 27 from above the masking tape 25, the masking tape 25 is peeled together with the metal film 26a which is formed on its top surface to leave the metal film 26a on only the region where the masking tape 25 is not formed.

The coating and drying operations of the adhesive agent can be performed efficiently, and the productivity in the metal back layer forming step can be improved by suppressing the generation of wrinkles which might be produced on the transfer film and also decreasing the adhesion of foreign substances onto the transfer film caused by static electricity.

Besides, the metal film 26a transferred in the press step can be pressed by the press roller or the like while heating. Then, organic components are decomposed and removed by calcining (baking) the metal film 26a together with the face plate 27 to a temperature of about 450° C. Thus, a phosphor surface with a metal back excelling in adhesiveness between the phosphor screen 22 and the metal back layer 29 can be obtained.

Then, the FED 21 having the formed phosphor surface with a metal back as an anode electrode will be described with reference to FIG. 3.

The FED 21 is configured so that the face plate 27 having the phosphor surface with a metal back formed in the embodiment and a rear plate 28 having an electron emission element 28a arranged in the matrix are disposed to opposite to each other with a small gap of about several millimeters between them, and a high voltage of 5 to 15 kV is applied between the face plate 27 and the rear plate 28. In the drawing, reference numeral 22 is a phosphor screen having a stripe light-absorbing layer and a phosphor layer, and 29 is a metal back layer. Reference numeral 31 denotes a support frame (side wall).

The gap between the face plate 27 and the rear plate 28 is extremely small, and discharge (dielectric breakdown) tends to occur between them, but the FED 21 has the metal back layer 29 which is free from unevenness, a crack or a wrinkle and has smoothness and flatness, and has high adhesiveness between the metal back layer 29 and the lower layer phosphor screen 22. Besides, display with high brightness, high color purity and outstanding reliability can be realized.

### EXAMPLE 1

Then, the present invention will be described in further detail with reference to an example. It is to be understood that the present invention is not limited to the following example. Here, a metal back layer was formed by using the above-described metal back layer forming device 1 shown in FIG. 1.

First, a stripe light-absorbing layer (light blocking layer) of a black pigment was formed on the inner surface of the face plate 27 by the photolitho method, a slurry containing a ZnS-based, Y₂O₃-based or Y₂O₂S-based phosphor of individual colors was coated, dried, and patterned was performed by the photolitho method. And, with the light blocking part, a phosphor layer of three colors of red (R), green (G) and blue (B) was formed to have them adjacent to each other in the shape of a stripe to form the phosphor screen 22. On the inner surface of the face plate 27, the peripheral black matrix 23 of a black pigment and the outer frame part 24 of a silver paste film were sequentially formed on the nondisplay region around the phosphor screen.

Then, a release agent layer having a thickness of 0.5 μm was formed on the transfer film F shown in FIG. 2, namely the polyester base film 26b having a thickness of 20 μm. A roll-shaped transfer film F having the metal film (Al film) 26a having a thickness of 80 nm formed by depositing Al was attached to the film withdrawing roller 2 on the upstream side of the metal back layer forming device 1 shown in FIG. 1. Then, the transfer film F was passed to the film winding roller 18 on the most downstream side through the film wrinkle-removing rollers 3, 5, the turn roller 9, the film holddown rollers 15, 16 and the tension rollers 17, and tension was applied through the tension rollers 17. Subsequently, a resin composition of 90 parts of toluene and 10 parts of vinyl acetate was coated onto the metal film (Al film) 26a of the transfer film F by means of the bar coater roller 6a of the adhesive agent coating equipment 6. Then, air of normal temperature (20° C.) was blown from the air blower 7 to the coated adhesive agent, and hot air (temperature of 80° C.) was blown from the drying machine 8 to form the adhesive film.

Then, the transfer film F was carried to the slide table 14 and disposed to come into contact with the phosphor screen (phosphor layer) 22 on the inner surface of the face plate 27 placed on the slide table 14. Then, pressing and adhering were performed by the rubber transfer roller 12 having hardness of 80 degrees and heated to a surface temperature of 200° C. at a speed of 4.0 m/min and a pressure of 500 krf/cm² Then the base film. 26b was peeled. Thus, the metal back layer (Al film layer) 29 was formed on the phosphor screen 22 of the face plate 27.

Then, the metal back layer (Al film layer) 29, which was transferred to the phosphor layer 22 on the inner surface of the face plate 27, was adhered by pressing at a speed of 1.0 m/min and a pressure of 900 kgf/cm² by a rubber press roller (not shown) having rubber hardness of 80 degrees and heated to a surface temperature of 175° C. Besides, the face plate 27 having the metal back layer (Al film layer) 29 formed by transferring as described above was heated (baked) at 450° C. to decompose and remove organic components to form a phosphor surface with a metal back. Then, the formed face plate 27 having the phosphor surface with a metal back was used to produce the FED 21 by a conventional method.

In other words, an electron generating source having surface conduction type electron emission elements formed in a large number in the shape of matrix on a substrate was fixed to a glass substrate to produce the rear plate 28. Then, the rear plate 28 and the face plate 27 were disposed opposite to each other with a support frame 26 and a spacer disposed between them, and sealed with frit glass. Then, necessary processes such as sealing and exhaust were performed to produce a 10-inch color FED. The produced FED 21 was subjected to a drive test at an electron accelerating voltage of 5 kV for 1000 hours, but a discharge phenomenon did not occur.

The present invention was specifically described with reference to the embodiments (and example) but the invention is not limited to the embodiments, but various modifications may be made without departing from the scone of the invention.

For example, it can also be configured so that the adhesive layer is previously formed on the metal film 26a, the transfer film F on which the adhesive layer is formed is wound by a method which has release paper sandwiched between the wound layers, and it is withdrawn from the withdrawing roller 2 to transfer onto the phosphor screen.

### INDUSTRIAL APPLICABILITY

According to the present invention, the metal back layer forming process that is realized by transferring the metal film and the adhesive layer which are on the transfer film to the phosphor layer of the face plate can be substantially automated, and production efficiency can be improved.

1. A metal back layer forming device, comprising:
a film withdrawing mechanism which withdraws, starting at one end, a transfer film from a wound body of the transfer film formed by applying at least a metal film onto a base film;
a film carrying mechanism which carries the transfer film withdrawn, starting at one end, by the film withdrawing mechanism to the downstream side;
a transfer mechanism which transfers the metal film via an adhesive layer by heating while pressing the transfer film carried by the film carrying mechanism against a phosphor surface disposed on the face plate; and
a film winding mechanism which winds while peeling the base film from the transfer film from which the metal film is transferred by the transfer mechanism.

2. The metal back layer forming device according to claim 1, further comprising an adhesive agent coating mechanism which coats an adhesive agent onto the metal film of the transfer film and an adhesive agent drying mechanism which dries the adhesive agent coated by the adhesive agent coating mechanism installed at a previous stage of the transfer mechanism.

3. The metal back layer forming device according to claim 1, further comprising a wrinkle-removing mechanism which removes wrinkles which might be produced on the transfer film on the downstream side in the vicinity of the film withdrawing mechanism and in the vicinity of the disposed position of the

4. The metal back layer forming device according to claim 2, further comprising a static elimination mechanism which removes static electricity from the electrostatically charged transfer film on the downstream side in the vicinity of the film withdrawing mechanism, on the side of the surface of the base film opposite to the adhesive agent coated surface of the transfer film on the downstream side of the adhesive agent coating mechanism, and in the vicinity of the disposed position of the transfer mechanism.

5. The metal back layer forming device according to claim 3, wherein a carrying speed of the transfer film by the film carrying mechanism can be adjusted in a range of 0.1 m/min to 10 m/min, and an adhesive agent coating time can be set in a unit of one second.

6. The metal back layer forming device according to claim 1, wherein the transfer mechanism is set to have a pressing force against the transfer film in a range of 300 to 1500 kg/cm² and a heating temperature in a range of 150 to 240° C.

7. The metal back layer forming device according to claim 1, further comprising:
a slide table which is disposed at a position opposite to the transfer mechanism with respect to the transfer film being carried by the film carrying mechanism and slidable in parallel to a carrying direction of the transfer film while placing thereon the face plate on which the phosphor surface is formed, wherein the slide table has a moving speed in a range of 0.5 m/min to 10 m/min.

8. The metal back layer forming device according to claim 1, further comprising:
a slide table which is disposed at a position opposite to the transfer mechanism with respect to the transfer film being carried by the film carrying mechanism and slidable in parallel to a carrying direction of the transfer film while placing thereon the face plate on which the phosphor surface is formed,
wherein the slide table has a moving speed in a range of 0.5 m/min to 10 m/min.
